(19) United States
(12) Patent Application Publication
(10) Pub. No.: US 2005/0110778 A1
(43) Pub. Date: May 26, 2005

(54) Wireless handwriting input device using grafitis and bluetooth

(76) Inventor: Mourad Ben Ayed, Tunis (TN)

Correspondence Address: DANIEL B. SCHEIN, P. O. BOX 28403, SAN JOSE, CA, 95159, US

(21) Appl. No.: 10/924,432

(22) Filed: Aug. 23, 2004

Related U.S. Application Data
(63) Continuation-in-part of application No. 09/729,968, filed on Dec. 6, 2000, now abandoned.
(60) Provisional application No. 60/524,928, filed on Nov. 25, 2003.

(51) Int. Cl. G09G 5/00

(52) U.S. Cl. 345/179

(57) ABSTRACT

Wireless input device apparatus allows a user to input data into cellular phones, personal digital assistant, TVs and computers . . . The user holds a wireless stylus and performs movements corresponding to graffiti. In the preferred embodiment, graffiti refers to PalmPilot graffiti. The wireless stylus identifies the user symbols and wirelessly sends them to a terminal device. In the preferred embodiment, the wireless stylus uses a BlueTooth transmitter for connecting and sending data to terminal devices, thus, the wireless stylus can be used for inputting data into any BlueTooth compliant system. In another embodiment, the wireless stylus sends the raw accelerometer data to a terminal device, which identifies the user symbols.

### PRIORITY

This application is a continuation-in-part of U.S. patent application Ser. No. 09/729,968 filed Dec. 6, 2000, and also claims priority of U.S. provisional patent application Ser. No. 60/524,928, filed Nov. 25, 2003, all of which are specifically incorporated by reference as if reproduced in full below.

### FIELD OF THE INVENTION

This invention relates to devices for transcribing motions in space of an item into data, and more specifically to transcribing motions of an item into symbols wherein the symbols can then be translated into characters that may be different from the symbols.

### BACKGROUND OF THE INVENTION

Conventional devices for inputting characters into electronic devices involve keyboards, voice synthesizers and stylus. A stylus is a plastic or metal stick used to write on a flat sensitive pad.

U.S. Pat. No. 5,517,579 (“Baron, et. Al.”), discloses a “Handwriting Input Apparatus for Handwriting Recognition Using more than one Sensing Technique”. The apparatus uses an electronic pen containing an accelerometer, and another sensing technique, in order to decipher handwriting. The device is complex, necessitates several components and wires.

U.S. Pat. No. 5,627,348 (“Berkson, et. Al.”) titled “Electronic Stylus with Writing Feel” uses a non marking writing instrument (stylus) and a sensitive writing surface that senses the stylus. This system is a two-part system.

U.S. Pat. No. 6,097,374 (“Howard, et. Al.) titled “Wrist Pendent Wireless Optical Keyboard” describes a system for sensing the presence or absence of human digit or a prosthetic appendage of a wrist. This system is complex not convenient as an input device.

U.S. Pat. No. 5,615,132 (“Horton, et. Al.”) describes a “Method and Apparatus for Determining Position and Orientation of a Moveable Object using Accelerometers”. This patent describes the application of accelerometers to simulation and games but does not describe its applicability to hand writing recognition.

U.S. Pat. No. 5,851,193 (“Arikka, et. Al.”) describes a “Method and Device for the Simultaneous Analysis of Ambulatorily Recorded Movements of an Individual's Different Body Parts”. This patent does not cover the application of accelerometers to hand writing recognition.

The previous systems present a number of disadvantages:
Bulky systems: all previous systems consist of 2 or more sub-systems;
Not easy to integrate: none of the previous devices can be easily integrated with a cellular phone or a personal digital assistant;
Reliability: most of the previous systems are not reliable in deciphering handwriting; and
Cost: most of the previous systems are complex, thus costly. Thus there is a need for a more convenient and reliable method and apparatus for inputting handwriting into any device cheaply and reliably.

### SUMMARY OF THE INVENTION

The present invention provides a device that consists of an electronic stylus entity that contains one or more accelerometers. The electronic stylus can be used to perform gestures in the air that correspond to graffiti, a set of symbols that correspond to alphanumeric characters. While in a preferred embodiment, the electronic stylus correlates output from accelerometers to graffiti symbols, this task can also be performed at the receiving terminal. The electronic stylus can correlate each graffiti symbol to a letter, number or other symbol.

The electronic stylus can use Bluetooth to send information to any Bluetooth compatible device.

Hence in a preferred embodiment, the present invention comprises a unitary device for converting symbols formed by tracking stylus movements in space to characters, comprising:
a stylus comprising:
at least one accelerometer for generating at least one first acceleration sequence by tracking movements of said stylus in space or upon a surface;
memory means for storing a collection of reference acceleration sequences, wherein the reference acceleration sequences correspond to at least one set of symbols, wherein the symbols correspond to a character set, at least one member of the character set being different in shape from at least one member of the at least one set of symbols;
a processor for comparing at least one first acceleration sequence generated by stylus movement to a set of reference acceleration sequences to identify a symbol and for converting the symbol to its corresponding character, wherein the shape of the character can be different from the shape of the symbol;
Bluetooth transceiver means for establishing a Bluetooth wireless connection with a second device in range and transmitting to the second device at least one character resulting from generating at least one first acceleration sequence when a wireless connection has been established therewith.

The Bluetooth transceiver means can supports the display of a generated character on a second device.

The present invention also includes a method for converting symbols formed by tracking stylus movements in space or upon a surface to characters, comprising: keeping a collection of reference data sequences, said reference data sequences corresponding to at least one set of symbols, wherein said symbols correspond to a character set, at least one member of said character set being different in shape from at least one member of said at least one set of symbols; on activation of said stylus, establishing a Bluetooth wireless connection with a second device using a transceiver means; tracking movements of said stylus in space or upon a surface using accelerometers and generating sensor data sequences; matching said sensor data sequences to said reference data sequences and identifying a character corresponding to said reference data sequences; on identification of a character, transmitting identified character to said second device, displaying said character corresponding to stylus movements on said second device.

Further, the present invention comprises an apparatus for capturing hand movements and for providing real-time feedback to a user using a stylus comprising:
a transceiver for automatically establishing a two-way wireless communication with a second device within a 100 meters radius, motion sensors onboard said stylus selected from the set comprised of an accelerometer, a gyroscope, an inclination sensor, a tilt sensor and a heading sensor, a processor onboard said stylus for processing sensors output and generating data sequences,
whereby said stylus automatically sends data sequences to said second device, and receives messages from said second device, whereby on receipt of a message from said second device, said stylus automatically performs actions corresponding to said messages selected from the set comprising: vibrating, issuing sound alerts, automatically correcting mistakes, activating an LED, displaying information on LCD or a combination of those actions.

What is Bluetooth? One of skill in the art is likely very familiar with Bluetooth and its specifications. Nevertheless, to facilitate explanation of the invention to those not of skill in the art, a short explanation is provided. Further details can be found in various publications. Bluetooth is a wireless specification delivering short-range radio communication between electronic devices that are equipped with specialized Bluetooth chips. It lets nearly all devices talk to one another by creating a common language between them. All devices such as cell phones, PDAs, pagers, stereos, and other home appliances can communicate and connect using Bluetooth technology to form a private, personal area network (PAN).

Technology Characteristics: The Bluetooth specification standard defines a short range (10-meter) radio link. The devices carrying Bluetooth-enabled chips can easily transfer data at a rate of about 720 Kbps (kilobits per second) within 10 meters (33 feet) of range through walls, clothing and luggage bags. The interaction between Bluetooth devices occurs by itself without direct human intervention whenever they are within each other's range. In this process, the software technology embedded in the Bluetooth transceiver chip triggers an automatic connection to deliver and accept the data flow.

Since Bluetooth is of short range with limited speed and low-power technology it is less attractive to corporate wireless local area networks that are generally powered with the 802.11 wireless LAN technology. Each Bluetooth-enabled device contains a 1.5-inch square transceiver chip operating in the ISM (industrial, scientific, and medical) radio frequency band of 2.40 GHz to 2.48 GHz. This frequency is generally available worldwide for free without any licensing restrictions. The ISM band is divided into 79 channels with each carrying a bandwidth of 1 MHz.

In each Bluetooth transceiver chip software is embedded, called a link controller. This mechanism performs the functions of identifying other Bluetooth devices, and connecting and transferring data.

How Bluetooth Operates: Whenever devices carrying Bluetooth technology are within each other's range, they create an automatic ad hoc PAN (personal area network) called a piconet. In this arrangement, one device acts as the “master” such as laptop or PDA, while other devices function as “slaves” such as printers, scanners, etc. A piconet normally carries up to eight devices. The master device decides if a particular communication service is needed from a slave device. At the time when a connection is made between Bluetooth devices, an exchange of unique Bluetooth identity called global ID takes place. A device globalID indicates its profile along with capability functions. Upon matching of the device profile a connection is made and as the devices exchange data, the Bluetooth transceiver chip hops back and forth among frequencies.

A scatternet forms if a device from one piconet also acts as a member of another piconet. In this scheme, a device being master in one piconet can simultaneously be a slave in the other one.

Security Limitations in Bluetooth: Due to the aspect of radio waves, experts fear a security concern with Bluetooth. The issue can be addressed with three aspects: specific sequence of channel hopping known only to the sending and receiving devices, challenge-response authentication routine to verify the validity of the receiving unit, and the 128-bit key encryption standard for securing transmission between devices.

Bluetooth Advantages: One can create a personal area network at home or on the road with Bluetooth-enabled devices such as keyboard, mouse, scanner, PDA, laptop, cell phone, etc. This network can automatically help synchronize notes, calendar, address book and also print pictures, receive emails, access cell phones messages, etc. It can even help consumers pay bills with credit card through Bluetooth cash register if a Bluetooth PDA stores the card information.

### BRIEF DESCRIPTION OF THE DRAWINGS

The present invention will be more clearly understood after reference to the following detailed specifications read in conjunction with the drawings wherein:

FIG. 1 is a schematic of an electronic stylus in accordance with the present invention.

FIG. 2 is a block diagram of an interactive electronic stylus.

FIG. 3 is a flowchart illustrating the operation of an interactive electronic stylus.

FIG. 3b is a flowchart illustrating the steps involved in receiving feedback from a second device.

FIG. 4 is an alternative flowchart illustrating the operation of an interactive electronic stylus.

Similar reference numerals are used in different figures to denote similar components.

### DETAILED DESCRIPTION OF THE PREFERRED EMBODIMENTS

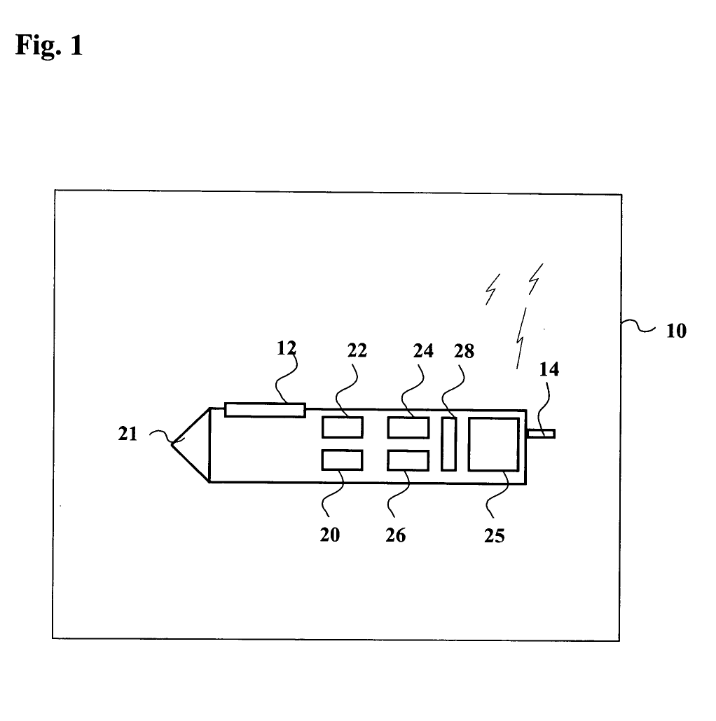

FIG. 1 is schematic of an electronic stylus 10 comprising a processor 20 interconnected with test sensors 21, an activation switch 12, motion sensors 22, a memory 28, a transceiver 26, a battery 24, an information center 25 and an antenna 14. Test sensors 21 and information center 25 are optional components. Activation switch 12 can be any type of button, switch, remote sensor, touch sensor, contact sensor or activation system. Activation switch 12 may comprise a biosensor to validate the identity of the stylus' user.

Motion sensors 22 are MEMS gyroscopes, MEMS accelerometers, or a combination of accelerometers and gyroscopes. Motion sensors 22 may comprise one or more tilt sensors. MEMS are microelectromechanical systems or microscopic machines with electrical and mechanical parts on a silicon chip. Gyroscopes can be any kind of angular rate sensors such as those manufactured by Analog Devices, which generate output signals that are indicative of angular rates. The output signals may be converted to data sequences using electronic components such as resistors and capacitors. Accelerometers can be any kind of acceleration sensors such as those manufactured by Analog Devices, which generate output signals that are indicative of the acceleration. The output signals are converted to data sequences.

Test sensors 21 can be any type of sensor such as sensor for contact, pH level, depth, smell, vibration, noise, liquidity, heat, gene (gene array) and humidity. Test sensor 21 can be a camera and can comprise other tools such as a light source, an ink cartridge and a tissue collection mechanism.

Transceiver 26 is any type of transceiver or a combination of transmitter and receiver. In a preferred embodiment, transceiver 26 conforms to BlueTooth specifications, 802.11, WiLAN, or any other communication protocol (BlueTooth may also be spelled Bluetooth, with both terms considered equivalent herein). Transceiver 26 establishes a temporary two-way connection or a piconet network with other devices equipped with compatible transceivers. The electronic stylus allows the user to connect to a second device and to transfer digital data to that device. The digital data can contain any type of data such as ASCII, streaming video, streaming data, IP packets, etc. The second device can be any device such as cellular phone, PDA, computer, TV, etc. In the course of establishing a connection, the second device may prompt the user to accept input from the stylus. After establishing a connection, data sent by the stylus may be displayed on a display onboard the second device or used in an application running on the second device. Stylus 10 receives real-time feedback from the second device using transceiver 26 and presents it to the user through information center 25.

Battery 24 provides power to some of the components of electronic stylus 10. It will be understood that battery 24 may be a fuel cell, nickel-cadmium, lithium, alkaline or nickel-hydride battery or any other portable source of electric power. Battery 24 can also be replaced with photovoltaic cells. When electronic stylus 10 is not in operation it remains in a dormant state (“sleep-mode”) to conserve the energy of battery 24.

Information center 25 can be any type of visual, audio, tactile or mechanical user interface means capable of conveying information to the user. An example of visual means is a liquid crystal display (“LCD”), a cathode ray tube, a plasma discharge display, an LED, or any visual information display device. Audio means can be any audio device such as a speaker. Tactile means can be any tactile sensor such as a heat-generating device. An example of a mechanical means is a vibrator.

Antenna 14 can be any type of antenna including patch antenna and dipole antennas.

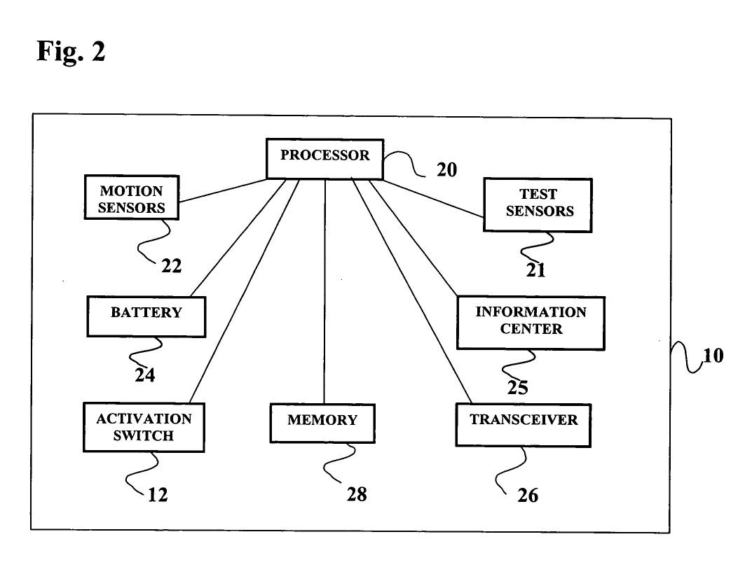

Referring now to FIG. 2, in one embodiment, electronic stylus 10 comprises a processor 20 interconnected with test sensors 21, an activation switch 12, motion sensors 22, a memory 28, a transceiver 26, a battery 24, and information center 25. Test sensors 21 and information center 25 are optional components.

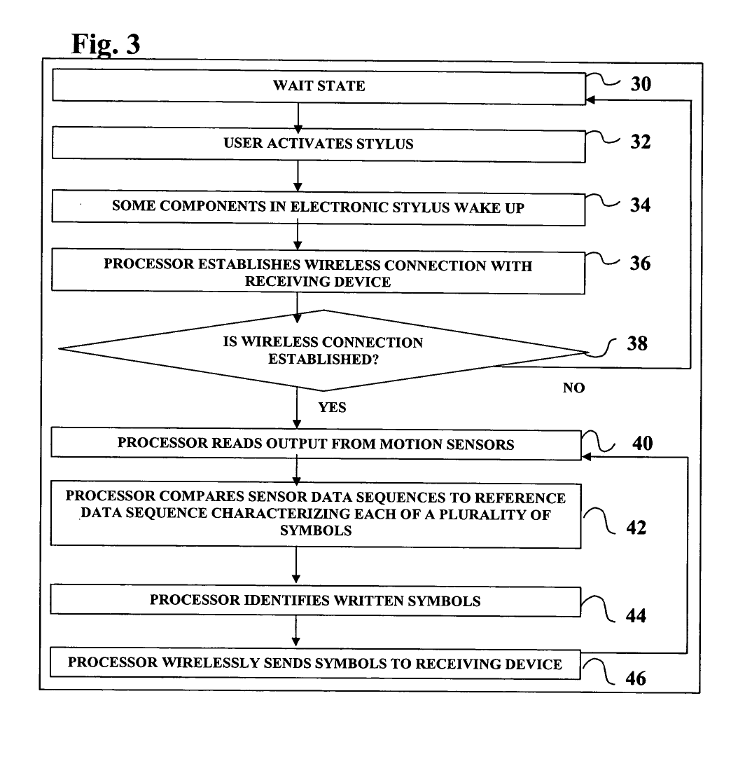

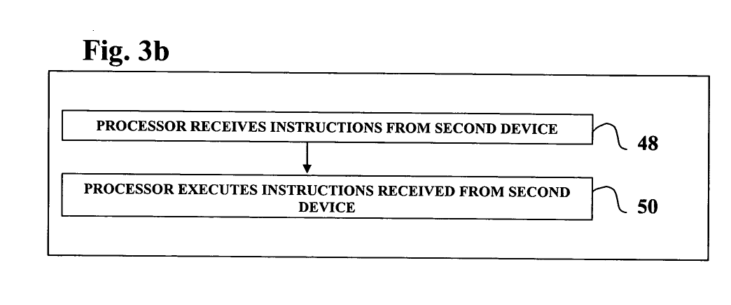

Turning now to FIG. 3, the flowchart illustrates the steps involved in identifying symbols and transferring symbols to a second device.

In step 32, the user aims stylus 10 to a second device equipped with a two-way wireless communication means such as Bluetooth and activates switch 12. Bluetooth allows devices within 100 meters range to automatically establish communication and to communicate with each other seamlessly. Some components of the stylus wake up in step 34. The stylus establishes a two-way wireless connection with the second device in step 36. The second device may prompt the user to accept the connection request from the stylus in order to complete the connection. If the request is accepted, the second device will accept data from the stylus and display it. If not, it will not accept data in step 38 and may revert to a wait state 30. The second device does not require any additional hardware to receive data from the stylus. If the second device does not have appropriate drivers or software, the stylus may transfer drivers and software to the second device.

Motion sensors 22 track the stylus movements and generate motion sensor data sequences representing the movements. Processor 20 reads the motion sensor data sequences in real-time in step 40 and matches them to reference data sequences in step 42. In doing so, processor 20 translates written symbols into output symbols, which may be different in shape from the written symbols. This feature is very useful when writing in 3D and is more powerful from straight transcription where there is a direct association between the shapes of the input and output symbols.

For example, in a translation system, a written Inverted “V” may correspond to an output of “A”, a “U” followed by a horizontal line may correspond to “YOU”, a circle and a line perpendicular to that circle may correspond to “THROUGH”. Translation also includes transcription.

Processor 20 computes correlation factors between the motion sensor data sequences and the reference data sequences, finds the match with the best correlation factor and generates symbols. A match is found if the correlation factors are high. Other statistical methods can be used to find matches between data sequences such as partial auto-correlation, the Fast Marching Method, elastic matching, etc. Other methods may be applied to filter and enhance the data sequences, for example, standard deviation, regression, Euler Transform and others.

In step 44, processor 20 generates characters that correspond to the identified reference data sequences. In step 44, processor 20 may compare the last two or more identified characters with a list of expressions in order to anticipate the next character to be entered by the user. If it succeeds, processor 20 sends the remaining characters in the expression to the second device. An expression is a grouping of three or more characters or symbols that is commonly used. For example, if the stylus identifies the characters “C” “0” “M” “P” “U” successively, the stylus may determine that the user is trying to write “COMPUTE” or “COMPUTER” and may send the characters “T” “E” to the second device. Processor 20 can check the list comprising the last two or more recently identified symbol since the last “SPACE” character.

In step 46, when one or more symbols or characters are identified, processor 20 sends the symbols to the second device through transceiver 26. The symbols may be displayed on a display onboard the second device.

REAL-TIME FEEDBACK: A further enhancement to the wireless pen is providing real-time feedback to the user through that device. A real-time feedback mechanism onboard the stylus may be appreciated in many applications. For example, the stylus can be used in teaching spelling or rehabilitating motion patients. A doctor can receive real-time feedback on a surgery and can have the information presented onboard the stylus. For example, the type of tissue being cut and recommendations on which direction to cut, etc. The doctor does not have to look at a computer monitor and can focus all attention on the surgery. Other applications include training, assembly, or any other application where a feedback mechanism is appreciated.

Turning now to FIG. 3b, the flowchart illustrates the steps involved in receiving feedback from a second device. Following sending symbols to a receiving device in step 46, in step 48, processor 20 receives instructions from said second device and executes those instructions in step 50. An instruction comprises a message and an indication of which user interface medium selected from information center 25 to use for the message.

Processor 20 may provide the user with real-time feedback. Processor 20 may run a spell checker on the recently identified characters. If an error is found, Processor 20 can transmit “delete” characters and new characters to the second device in order to change the displayed characters. Processor 20 may also warn the user that there has been a spelling error through visual, audio or mechanical means. For example, processor 20 can activate an LED, display a message on an LCD, issue a sound warning or activate a vibrator onboard the stylus.

The stylus may detect movements that indicate a change of mode. For example, a sharp vertical up-down movement may indicate “Upper Case Mode” and a sharp vertical down-up movement may indicate a “Lower Case Mode”. Alternatively, the user can change the mode by conveying voice instructions through a microphone. Processor 22 may select different reference data or motion sensor data sequences for its comparison based on the current operation mode. The stylus may convey the current operation mode to the user using an information center 25.

In a preferred embodiment, the stylus can learn gestures from the user corresponding to specific symbols or group of symbols or characters. Sampling motion sensor data sequences generates reference data sequences for a symbol. The samples for a symbol are captured in a controlled environment and stored in memory. Motion sensor data sequences are output from sensors that represent variations in a sensed condition over time.

The stylus may detect movements that indicate a change to a learning mode. In a learning mode, the user makes movements using the stylus and provides the computerized symbols corresponding to the movements. Since the stylus does not have a keyboard, the user may enter the symbols using a keyboard onboard a second device and transfer those symbols to the pen. In a learning scenario, MEMS motion sensors 22 capture the movements and processor 20 generates data sequences corresponding to those movements. Processor 20 collects one or more symbols from the user corresponding to those movements and stores the data sequences and corresponding symbols as part of the reference data sequences library onboard the stylus.

Stylus 10 can be used on horizontal, vertical, inclined surfaces or in space. Stylus 10 may comprise a tilt sensor to sense if the stylus is in a horizontal, vertical or inclined position. Processor 20 may use the tilt sensor data to select different reference data sequences, to calibrate the motion sensor data sequences before correlating them to the reference data sequences, or to select different sensor data sequences.

In another embodiment, motion sensors 22 are mounted on a rotate-able surface so that the sensor is kept in the same orientation regardless of the stylus being held in a different orientation.

In another embodiment, the stylus may request the user to enter a password or a signature using the stylus before it starts operating.

When the stylus connects to a second device, the second device may also prompt the user to enter a password or a signature in order to authenticate the user of the stylus.

In another embodiment, the stylus transmits software or drivers to the second device. The software may facilitate communication between the stylus and second device or may be used to decrypt codes send by the stylus. Also, in another embodiment, the stylus receives information from the second device such as dictionary entries, grammar rules, or any configuration information.

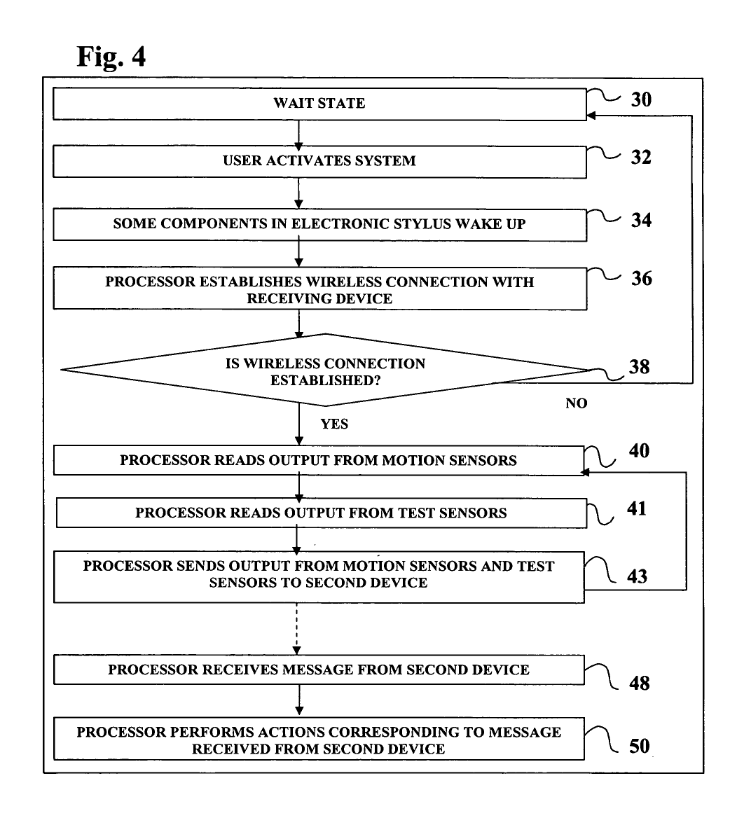

Turning now to FIG. 4, the flowchart illustrates the steps involved in capturing and transferring data streams to a second device and receiving real-time feedback. In step 32, the user aims stylus 10 to a second device equipped with a two-way wireless communication means and activates switch 12. Some components in stylus 10 wake up in step 34 and stylus 10 establishes a two-way wireless connection with the second device in step 36. The second device may prompt the user to accept the connection request from the stylus. If the request is accepted, the second device will accept data from the stylus and display it. If not, it will not accept data in step 38 and may revert to a wait state 30. If the second device does not have appropriate drivers or software, the stylus may transfer drivers and software to second device.

Motion sensors 22 track the stylus movements and generate motion sensor data sequences representing the movements in step 40. Test sensors 21 generate test data sequences in step 41. Processor 20 collects motion sensor data sequences from motion sensors 22 and test sensor data sequences from test sensors 21 and sends them to second device. The second device processes the data and sends real-time feedback to the stylus.

The second device processes the data and sends feedback to stylus 10 relating to the data. Examples of the feedback are:
a warning about a spelling or grammatical error,
an instruction to take a corrective action,
a recommendation for a specific procedure or course of action,
a hint or an interactive help menu,
statistical or historical data,
a warning about exceeding a threshold,
information about contact surface or contact tissue etc.

The feedback can be any information resulting from data analysis.

In step 48, Processor 20 receives messages from said second device and performs actions corresponding to said messages in step 50. A message may comprise an action to be performed such as activating a vibrator, a text message to be displayed on an LCD or communicated through a speaker, a LED to be lit, an email/SMS to be sent, etc.

In a preferred embodiment, test sensors 21 comprise a camera, a light source and an ink cartridge that collaborate to take snapshots of ink imprints. The light source can be any type of light emitter including regular light source, ultraviolet light, infrared, x-rays, or any electromagnetic wave emitter. The camera can be any type of light wave sensor such as CCD (charge coupled devices), CMOS (complementary metal oxide semiconductor technology), light sensitive diodes, scanner or any type of electromagnetic sensor. The ink cartridge can be any kind of ink cartridge including an array of ink cartridges and may comprise a sensor for detecting the color of the ink being used and for sending the information to processor 20. The Camera captures snapshots of the ink representing writing or drawing on any surface. Processor 20 may filter the snapshot data to remove background noise. Processor 20 sends the motion sensor data sequences and the camera snapshots to the second device. A software onboard the second device assembles the snapshots based on their relative position in time and in space with respect to the previous snapshot.

In another embodiment, the software for assembling the snapshots runs on the stylus and generates BITMAP, GIP or JPEG data that can be streamed to second device.

In another preferred embodiment, stylus 10 is used as a surgical instrument.

Test sensor 21 may analyze tissue in a surgery, send sensor information to a server, which in turn provides information useful to the surgeon.

Test sensor 21 may detect the course of a surgical cut or detect surgeon's hand vibration, send sensor information to a server, which in turn provides information and recommendations about the cut and the surgery onboard the stylus.

In another preferred embodiment, stylus 10 is used as a controlling device in robotics and in games. Stylus 10 sends sensory information wirelessly, for example, temperature, hand pressure, finger positions, touch, pat, tap, pitch, roll to a second device which replies with messages, sound, motion, vibration onboard said stylus.

In another preferred embodiment, test sensors 21 comprise a tissue collector that collects tissue and sends it to a tissue analysis system. The stylus receives information in real-time indicating the properties of the collected tissue and displays that information on an onboard display system.

Numerous other modifications, variations, and adaptations may be made to the particular embodiment of the invention described above without departing from the scope of the invention, which is defined in the claims. Hence, while exemplary embodiments of the present invention have been set forth above, it is to be understood that the pioneer inventions disclosed herein may be constructed or used otherwise than as specifically described.

1. A unitary apparatus for converting symbols formed by tracking stylus movements in space to characters, comprising:
a stylus comprising:
at least one accelerometer for generating at least one first acceleration sequence by tracking movements of said stylus in space or upon a surface;
memory means for storing a collection of reference acceleration sequences, wherein the reference acceleration sequences correspond to at least one set of symbols, wherein the symbols correspond to a character set, at least one member of the character set being different in shape from at least one member of the at least one set of symbols;
a processor for comparing at least one first acceleration sequence generated by stylus movement to a set of reference acceleration sequences to identify a symbol and for converting the symbol to its corresponding character, wherein the shape of the character can be different from the shape of the symbol;
Bluetooth transceiver means for establishing a bluetooth wireless connection with a second device in range and transmitting to the second device at least one character resulting from generating at least one first acceleration sequence when a wireless connection has been established therewith.

2. The apparatus of claim 1, wherein said communication means complies with Bluetooth specifications.

3. The apparatus of claim 1, wherein said transceiver means complies with Bluetooth specifications.

4. The apparatus of claim 1, further comprising an activation system.

5. The apparatus of claim 4, wherein said activation system comprises a button.

6. The apparatus of claim 4, wherein upon activation of said activation system, at least one of said at least one accelerometer is activated.

7. The apparatus of claim 4, wherein upon activation of said activation system, said processor is activated.

8. The apparatus of claim 1, further comprising at least one set of reference acceleration sequences stored in said memory.

9. The apparatus of claim 1, further comprising at least one set of characters stored in said memory, said set of characters corresponding to at least one set of acceleration sequences.

10. The apparatus of claim 9, further comprising at least one set of reference acceleration sequences stored in said memory, at least a portion of said set of reference acceleration sequences corresponding to said at least one set of characters.

11. A method for converting symbols formed by tracking stylus movements in space or upon a surface to characters, comprising: keeping a collection of reference data sequences, said reference data sequences corresponding to at least one set of symbols, wherein said symbols correspond to a character set, at least one member of said character set being different in shape from at least one member of said at least one set of symbols; on activation of said stylus, establishing a Bluetooth wireless connection with a second device using a transceiver means; tracking movements of said stylus in space or upon a surface using accelerometers and generating sensor data sequences; matching said sensor data sequences to said reference data sequences and identifying a character corresponding to said reference data sequences; on identification of a character, transmitting said identified character to said second device, and displaying said character corresponding to stylus movements on said second device.

12. The method of claim 11, comprising checking spelling on the series of the last identified characters and on detection of a spelling error, performing an action selected from the set comprising vibrating, issuing sound alerts, automatically correcting mistakes, activating an LED and displaying information on LCD, or a combination of those actions.

13. An apparatus for capturing hand movements and for providing real-time feedback to a user using a stylus comprising:
a transceiver for automatically establishing a two-way wireless communication with a second device within a 100 meters radius,
motion sensors onboard said stylus selected from the set comprised of an accelerometer, a gyroscope, an inclination sensor, a tilt sensor and a heading sensor,
a processor onboard said stylus for processing sensors output and generating data sequences,
whereby said stylus automatically sends data sequences to said second device, and receives messages from said second device,
whereby on receipt of a message from said second device,
said stylus automatically performs actions corresponding to said messages selected from the set comprising: vibrating, issuing sound alerts, automatically correcting mistakes, activating an LED, displaying information on LCD or a combination of those actions.

14. The apparatus of claim 13, comprising test sensors onboard said stylus for sensing environment conditions,
wherein said test sensors are selected from the group comprised of a contact sensor, an odour sensor, a thermometer, a touch sensor, an activation switch, a camera, a microphone, a colour sensor, an ink cartridge sensor, a pH sensor, a depth sensor, a smell sensor, a vibration sensor, a liquid sensor, a humidity sensor, a composition sensor, a gene sensor, a gene array, a magnetic sensor, an infrared sensor or a combination of those sensors,
said processor processes test sensors output and generates data sequences, and said stylus automatically sends data sequences to said second device.

15. The apparatus of claim 13, wherein:
said stylus comprises an ink cartridge for dispensing ink,
said test sensors comprise a camera for capturing snapshots of user's hand drawings,
and wherein processing sensors output comprises assembling said snapshots according to information contained in said data sequences, and constructing a graphical data stream representing the drawings.

16. The apparatus of claim 13, comprising memory with reference data,
said reference data sequences represent symbols that correspond to characters, numbers, symbols and words, at least one of those symbols is different in shape from its corresponding entity,
and wherein said processor compares at least one first acceleration sequence generated by stylus movement to a set of reference acceleration sequences to identify a symbol and for converting the symbol to its corresponding character, wherein the shape of the character can be different from the shape of the symbol.

17. The apparatus of claim 13, comprising memory with software drivers, and wherein said stylus transmits one or more software drivers to said second device.

18. The method of claim 11, comprising comparing the last two or more identified characters with a list of expressions, anticipating the next characters to be entered and sending the next characters to the second device.
